(19) United States
(12) Patent Application Publication
(10) Pub. No.: US 2015/0175478 A1
(43) Pub. Date: Jun. 25, 2015

(54) TEXTURED GLASS SURFACE AND METHODS OF MAKING

(71) Applicant: Corning Incorporated, Corning, NY (US)

(72) Inventors: Vasudha Ravichandran, Painted Post, NY (US); Christine Coulter Wolcott, Horseheads, NY (US)

(21) Appl. No.: 14/408,055

(22) PCT Filed: Jul. 12, 2013
(86) PCT No.: PCT/US13/50296

§ 371 Date: Dec. 15, 2014

Related U.S. Application Data
(60) Provisional application No. 61/670,835, filed on Jul. 12, 2012.

(51) Int. Cl. C03C 15/00; B24C 1/00; C03C 21/00

(52) U.S. Cl. CPC C03C 15/00; C03C 21/002; B24C 1/00

(57) ABSTRACT

A method of making an article having a textured glass surface, including, for example: grit blasting a portion of the surface of a non-ion exchanged glass work piece; acid etching at least a portion of the grit blasted surface of the glass work piece; and ion exchanging the surface of the acid etched and grit blasted glass work piece. A glass article prepared by the method including: at least one anti-glare surface having excellent haze, distinctness-of-image, surface roughness, and uniformity properties, as defined herein.

### CROSS-REFERENCE TO RELATED CO-PENDING APPLICATION(S)

This application claims the benefit of priority under 35 U.S.C. §119 of U.S. Provisional Application Ser. No. 61/670,835, filed Jul. 12, 2012, the content of which is relied upon and incorporated herein by reference in its entirety.

This application is related to commonly owned and assigned co-pending application U.S. patent application Ser. No. 13/090,561, filed on Apr. 20, 2011, entitled “Anti-Glare Surface Treatment Method and Articles Thereof”, but does not claim priority thereto.

The entire disclosure of any publication or patent document mentioned herein is incorporated by reference.

### BACKGROUND

The disclosure relates generally to methods of making and using a textured glass surface, such as having a textured surface optionally having anti-glare surface properties, and to articles thereof. Textured glass having high surface roughness can be used in touch or tactile devices such as a track pad, e.g., Apple Magic Trackpad, and key board decks on lap top computers. Many of these surfaces are currently made of, for example, textured plastics or resins. These textured plastics or resins materials do not have the abrasion resistance of glass and can wear out with repeated use.

### SUMMARY

The disclosure provides a method of making an anti-glare (AG) surface texture, and articles made by the method. The method includes grit blasting and acid etching the surface of a non-ion exchanged glass work piece, followed by ion exchange.

### BRIEF DESCRIPTION OF THE DRAWING(S)

In embodiments of the disclosure:

FIG. 1 shows an exemplary flow chart for the disclosed process.

FIGS. 2A and 2B, respectively, show micrograph images after grit blasting for a comparative process having surface chips, and an inventive process having no chips or significant chip reduction.

FIG. 3 shows an exemplar of acceptable glass thickness loss in etching.

FIG. 4 is a schematic showing surface transformation during etching of the grit blasted surface.

FIG. 5 shows the effect of acid concentration and etch time on haze properties.

FIG. 6 shows the effect of acid concentration and etch time on the distinctness of image (DOI) properties.

FIG. 7 shows a Weibull plot that compares a Gorilla® glass (control) with an experimental glass specimen of the disclosure that has been grit blasted with 1500 mesh white alumina and etched with acid.

FIG. 8 shows a correlation between transmitted haze and surface roughness parameters.

FIG. 9 shows glass thickness loss as a function of the etch time and acid concentration.

### DETAILED DESCRIPTION

Various embodiments of the disclosure will be described in detail with reference to drawings, if any. Reference to various embodiments does not limit the scope of the invention, which is limited only by the scope of the claims. Additionally, any examples set forth in this specification are not limiting and merely set forth some of the many possible embodiments of the claimed invention.

In embodiments, the disclosed articles, and the disclosed methods of making and use provide one or more advantageous features or aspects, including for example as discussed below. Features or aspects recited in any of the claims are generally applicable to all facets of the invention. Any recited single or multiple feature or aspect in any one claim can be combined or permuted with any other recited feature or aspect in any other claim or claims.

### DEFINITIONS

“Features” refer to, for example, contiguous areas of glass either differentially etched (e.g., pits), or higher elevation domains (e.g., mounds, plateaus, or “lands”).

“Anti-glare”, “AG”, or like terms refer to a physical transformation of light contacting the treated surface of an article, such as a display, of the disclosure that changes, or to the property of changing light reflected from the surface of an article, into a diffuse reflection rather than a specular reflection. In embodiments, the surface treatment can be produced by mechanical, chemical, electrical, and like etching methods, or combinations thereof. Anti-glare does not reduce the amount of light reflected from the surface, but only changes the characteristics of the reflected light. An image reflected by an anti-glare surface has no sharp boundaries. In contrast to an anti-glare surface, an anti-reflective surface is typically a thin-film coating that reduces the reflection of light from a surface via the use of refractive-index variation and, in some instances, destructive interference techniques. Typical anti-reflection coatings do not diffuse light; the amount of light that is still reflected from an anti-reflection coating is specular and reflected images are still sharp, though with a lower intensity.

“Contacting” or like terms refer to a close physical touching that can result in a physical change, a chemical change, or both, to at least one touched entity. In the present disclosure various particulate attaching techniques, such as spray coating, dip coating, slot coating, and like techniques, can provide a particulated surface when particulated with particles as illustrated and demonstrated herein. Additionally or alternatively, various chemical treatments of the particulated surface, such as spray, immersion, dipping, and like techniques, or combinations thereof, as illustrated and demonstrated herein, can provide an etched surface when contacted with one or more etchant compositions.

“Distinctness-of-reflected image,” “distinctness-of-image,” “DOI” or like term is defined by method A of ASTM procedure D5767 (ASTM 5767), entitled “Standard Test Methods for Instrumental Measurements of Distinctness-of-Image Gloss of Coating Surfaces.” In accordance with method A of ASTM 5767, glass reflectance factor measurements are made on the at least one roughened surface of the glass article at the specular viewing angle and at an angle slightly off the specular viewing angle. The values obtained from these measurements are combined to provide a DOI value. In particular, DOI is calculated according to equation (1):

$$DOI = [ 1 - \frac{Ros}{Rs} ] \times 100 \qquad ( 1 )$$

where Rs is the relative amplitude of reflectance in the specular direction and Ros is the relative amplitude of reflectance in an off-specular direction. As described herein, Ros, unless otherwise specified, is calculated by averaging the reflectance over an angular range from 0.2° to 0.4° away from the specular direction. Rs can be calculated by averaging the reflectance over an angular range of ±0.05° centered on the specular direction. Both Rs and Ros were measured using a goniophotometer (Novo-gloss IQ, Rhopoint Instruments) that is calibrated to a certified black glass standard, as specified in ASTM procedures D523 and D5767. The Novo-gloss instrument uses a detector array in which the specular angle is centered about the highest value in the detector array. DOI was also evaluated using 1-side (black absorber coupled to rear of glass) and 2-side (reflections allowed from both glass surfaces, nothing coupled to glass) methods. The 1-side measurement allows the gloss, reflectance, and DOI to be determined for a single surface (e.g., a single roughened surface) of the glass article, whereas the 2-side measurement enables gloss, reflectance, and DOI to be determined for the glass article as a whole. The Ros/Rs ratio can be calculated from the average values obtained for Rs and Ros as described above. “20° DOI,” or “DOI 20°” refers to DOI measurements in which the light is incident on the sample at 20° off the normal to the glass surface, as described in ASTM D5767, in this instance, the ‘specular direction’ is defined as −20°. The measurement of either DOI or common gloss using the 2-side method can best be performed in a dark room or enclosure so that the measured value of these properties is zero when the sample is absent.

For anti-glare surfaces, it is generally desirable that DOI be relatively low and the reflectance ratio (Ros/Rs) of eq. (1) be relatively high. This results in visual perception of a blurred or indistinct reflected image. In embodiments, the at least one roughened surface of the glass article has a Ros/Rs greater than about 0.1, greater than about 0.4, and greater than about 0.8, when measured at an angle of 20° from the specular direction using the 1-side method measurement. Using the 2-side method, the Ros/Rs of the glass article at a 20° angle from the specular direction is greater than about 0.05. In embodiments, the Ros/Rs measured by the 2-side method for the glass article is greater than about 0.2, and greater than about 0.4. Common gloss, as measured by ASTM D523, is insufficient to distinguish surfaces with a strong specular reflection component (distinct reflected image) from those with a weak specular component (blurred reflected image). This can be attributable to the small-angle scattering effects that are not measureable using common gloss meters designed according to ASTM D523.

“Transmission haze,” “haze,” or like terms refer to a particular surface light scatter characteristic related to surface roughness. Haze measurement is specified in greater detail below.

“Roughness,” “surface roughness (Ra),” or like terms refer to, on a microscopic level or below, an uneven or irregular surface condition, such as an average root mean squared (RMS) roughness or RMS roughness described below.

“ALF” or “average characteristic largest feature size” or like terms refer to a measure of surface feature variation in the x- and y-directions, i.e., in the plane of the substrate, as discussed further below.

“Uniformity,” “uniform,” or like terms refer to the surface quality of an etched sample. Surface uniformity is commonly evaluated by human visual inspection at various angles. For example, the glass article sample is held at about eye level, and then slowly turned from 0 to 90 deg., under a standard, white fluorescent light condition. When no pin-holes, cracks, waviness, roughness, or other like defects can be detected by the observer, the surface quality is deemed “uniform”; otherwise, the sample is deemed not uniform. “Good” or “OK” ratings mean that the uniformity is acceptable or satisfactory with the former being subjectively better than the latter.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example: through typical measuring and handling procedures used for preparing materials, compositions, composites, concentrates, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. The claims appended hereto include equivalents of these “about” quantities.

“Consisting essentially of” in embodiments can refer to, for example:

a method of making an article having a textured glass surface, comprising:

grit blasting a portion of the surface of a non-ion exchanged glass work piece;

acid etching at least a portion of the grit blasted surface of the glass work piece; and

ion exchanging the surface of the acid etched and grit blasted glass work piece; or

a glass article prepared by the foregoing process.

The method of making the article, the article or device, compositions, formulations, or any apparatus of the disclosure, can include the components or steps listed in the claims, plus other components or steps that do not materially affect the basic and novel properties of the compositions, articles, apparatus, or methods of making and use of the disclosure, such as particular reactants, particular additives or ingredients, a particular agent, a particular surface modifier or condition, or like structure, material, or process variable selected. Items that may materially affect the basic properties of the components or steps of the disclosure or that may impart undesirable characteristics to the present disclosure include, for example, a surface having objectionable high glare or high gloss properties, for example, having a haze, a distinctness-of-image, a surface roughness, a uniformity, or a combination thereof, that are beyond the values, including intermediate values and ranges, defined and specified herein.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, and like abbreviations).

Specific and preferred values disclosed for components, ingredients, additives, and like aspects, and ranges thereof, are for illustration only; they do not exclude other defined values or other values within defined ranges. The compositions, apparatus, and methods of the disclosure can include any value or any combination of the values, specific values, more specific values, and preferred values described herein.

A display with a smooth glass surface can be difficult to view due to glare produced when light is reflected from its surface. Antiglare (AG) surfaces are preferred for many display applications (e.g., computer monitor, handheld devices, work pads, laptops, and like devices), since the amount of specular (mirror-like) reflection is reduced.

AG glass surfaces for displays or non-display devices or articles can be produced by, for example, adding a polymer film to the glass, coating the glass with a coat having AG properties, or by adding light-scattering texture to the customer facing glass surface. Of these examples, textured ion-exchanged glass is preferred since it is more scratch resistant than a polymer coating. One method to add texture to glass is to grit blast and acid etch the glass to selectively remove domains of glass.

In the above mentioned copending application, U.S. Ser. No. 61/484,326, disclosed etch masks contain particles having an average particle size of less than 20 micrometers. The particles can be adhered to the glass by various methods, and depending on type and chemistry of adhesion, can provide the acid resistant phase of an etch mask. The process of making AG glass surfaces with an acid etch can include, for example, providing clean glass; applying a mask layer; etching the masked surface; and optionally rinsing and drying the resulting textured glass surface.

Chemically strengthened glasses are used in many handheld and touch-sensitive devices as display windows and cover plates where resistance to mechanical damage can be significant to the visual appearance and functionality of the product. During chemical strengthening, larger alkali ions in a molten salt bath are exchanged for smaller mobile alkali ions located within a certain distance from the glass surface. The ion-exchange process places the surface of the glass in compression, allowing it to become more resistant to any mechanical damage it is commonly subjected to during use.

Reduction in the specular reflection, a significant factor in glare, from many display surfaces is often desired, especially by manufacturers whose products are designed for outdoor use where glare can be exacerbated by sunlight. One way to reduce the intensity of the specular reflection is to roughen the glass surface or cover it with a textured film. The dimensions of the roughness or texture should be large enough to scatter visible light, producing a slightly hazy or matte surface, but not too large as to significantly affect the transparency of the glass. Textured or particle-containing polymer films can be used when maintaining the properties (e.g., scratch resistance) of the glass substrate are not important. While these films may be cheap and easy to apply, they are subject to easy abrasion which can reduce the display functionality of the device. Another shortfall of using films or coatings is that they can interfere with the operation of, or diminish the performance of certain touch-sensitive devices. Another approach to roughening the glass surface is chemical etching. U.S. Pat. Nos. 4,921,626, 6,807,824, 5,989,450, and WO2002/053508, mention glass etching compositions and methods of etching glass with the compositions. Wet etching is a method of generating an anti-glare surface on the glass while preserving its inherent mechanical surface properties. During this process, the glass surface is exposed to chemicals which degrade the surface to the correct roughness dimensions for the scattering of visible light. When micro-structural regions having differential solubility are present, such as in soda lime silicate glasses, a roughened surface can be formed by placing the glass in a (typically fluoride-ion containing) mineral acid solution. Such selective leaching or etching is generally ineffective at generating a uniform, anti-glare surface on other display glasses lacking such differentially soluble micro-structural regions, such as alkaline earth aluminosilicates and mixed alkali borosilicates, and for alkali and mixed alkali aluminosilicates containing, for example, lithium, sodium, potassium, and like compositions, or combinations thereof.

In embodiments, the disclosed process of texturing glass is applicable to, for example, Eagle™, soda lime and like glass compositions, and other glass compositions. The blasting and etching conditions can be controllably be varied to increase or decrease the surface roughness properties.

U.S. Pat. No. 6,527,628, to Ito, et al., mentions a first step of grit blasting, and the final step is brush cleaning. However, no acid etching involved. WO2010/35921A, to Lee, et al, mentions a touch panel using tempered glass, which glass is used for a touch device having no surface roughness or texturing.

In embodiments, the disclosure provides a method of making an article having a textured glass surface, comprising: grit blasting a portion of the surface of a non-ion exchanged glass work piece; acid etching at least a portion of the grit blasted surface of the glass work piece; and ion exchanging the surface of the acid etched and grit blasted glass work piece.

In embodiments, grit blasting can be accomplished by, for example, a wet blasting process that uses particle grit comprising or consisting of, for example, alumina particles, silicon carbide particles, or a mixtures thereof, that are made into a slurry with water or like liquid vehicle. The particle loading can be, for example, from about 2 to about 20 wt %. In embodiments, the grit blasting can alternatively be accomplished dry. In dry blasting, grits can include, for example, alumina, silicon carbide, glass beads, or mixtures thereof. The grit particle size in the dry or the wet method can be, for example, from about 10 to about 200 microns, from 10 to 50 microns, 5 to 50 microns, 2 to 50 microns, including intermediate values and ranges. The grit blasting can include, for example, exposing the glass surface to the grit blast particles for from about 1 to about 100 grams per minute, such as 30 m/min, for from 1 to 50 passes, using 1 to 5 nozzles. In embodiments, the glass surface can be, for example, at least one of a soda lime silicate glass, an alkaline earth aluminosilicate glass, an alkali aluminosilicate glass, an alkali borosilicate glass, a boroaluminosilicate glass, and like materials, or a combination thereof. In embodiments, the grit particles can be comprised of, for example, silicon carbide particles, and the etchant can be comprised of, for example, at least one acid selected from HF, H₂SO₄, HCl, HNO₃, H₃PO₄, and like etchants, or a combination thereof.

In embodiments, the contacting with an etchant can be, for example, exposing the glass surface having the attached microencapsulated particles to the etchant for about 1 second to about 30 minutes, including intermediate values and ranges, including intermediate values and ranges, such as about 10 seconds to about 10 minutes, about 20 seconds to about 1 minute, and like exposures or intervals.

In embodiments, the method can further comprise treating the resulting roughened surface with a low-surface energy coating, for example, a fluorinated compound, to reduce wetting and permit easy clean-up.

In embodiments, the method can further comprise washing, drying, or both any of the resulting grit blasted, acid etched, or chemically strengthening surfaces, and like treatments, or a combination thereof.

In embodiments, the method can further comprise, prior to etching, contacting at least another surface of the article with an optionally removable, etch-resistant protective layer that prevents etching in the protected area.

In embodiments, the disclosure provides a glass article prepared by any of the disclosed methods of making. The glass article can be, for example, a sheet of glass of a display or non-display device.

The glass surface can be, for example, at least one of a soda lime silicate glass, an alkaline earth aluminosilicate glass, an alkali aluminosilicate glass, an alkali borosilicate glass, a boroaluminosilicate glass, or a combination thereof, the particles are comprised of at least one wax, polymer, or a combination thereof, and the etchant comprises at least one acid selected from HF, H₂SO₄, HCl, HNO₃, H₃PO₄, or a combination thereof.

In embodiments, the method can optionally further include, for example: removing any residual particles from the glass surface after the etching step; removing any protective film layers; or a combination thereof. The method can also optionally further include, for example, subsequent etching steps after the particles and any protective films have been removed from the glass. These subsequent etching steps may or may not further modify the surface roughness profile of the glass or the glass surface chemistry.

In embodiments, the disclosure provides a surface textured glass article prepared by the aforementioned process or any process permutations.

The resulting surface textured glass article can be, for example, a distribution of topographic features having a characteristic lateral period of about 1 to about 100 micrometers. Lateral period synonymously refers to the average characteristic largest feature size (ALF). ALF is the average cross-sectional linear dimension of the largest 20 repeating features within a viewing field on a roughened surface, and as further mentioned below.

In embodiments, the method can further comprise, prior to etching, contacting at least another surface of the article with an optionally removable, etch-resistant protective layer.

In embodiments, the method can further comprise, after etching, washing the resulting anti-glare surface, chemically strengthening the anti-glare surface, or a combination thereof.

In embodiments, the disclosure provides a glass article prepared by any of the aforementioned processes including combinations or permutations thereof.

In embodiments, the glass article can have anti-glare surface having, for example, a distribution of topographic features having, for example, an average diameter of about 1 to about 100 micrometers. A preferred diameter for topographic features can be, for example, from about 0.1 to about 20 micrometers, including intermediate values and ranges.

In embodiments, a preferred haze, for example, for display-cover applications, can be, for example, less than about 10, an even more preferred haze can be, for example, about 6 to about 9, and an even more preferred haze can be, for example, about 5 to about 6 or below, including intermediate values and ranges. In embodiments, a preferred haze, for example, for non-display-cover applications such as appliances, mouse pads, light diffusers, decorative windows, and like articles, can be, for example, greater than about 30, an even more preferred haze can be, for example, about 35 to about 60, and an even more preferred high haze can be, for example, about 40 to about 80, including intermediate values and ranges.

A known etching process to produce an anti-glare layer on a glass surface can involve at least three baths. For example, the first bath can contain ammonium bifluoride (ABF), for growing ABF crystals on the glass surface. The second bath can contain H₂SO₄ acid to remove the crystals. The third bath can be a mixture of H₂SO₄/HF to smooth the glass surface. Typical processing times, from start to finish for the three-bath process, can be for example, of about 60 about 80 minutes.

In embodiments, the at least one surface of the article can be, for example, a glass, a composite, a ceramic, a plastic or resin based material, and like materials, or combinations thereof. In embodiments, the contacting of the particulated surface with an etchant can be accomplished by, for example, exposing the grit blasted surface to the etchant, for example, for from about 1 second to about 30 minutes, including intermediate values and ranges, such as about 10 seconds to about 10 minutes, about 20 seconds to about 1 minute, and like exposures or intervals.

In embodiments, the preparative method can optionally further include, for example, washing the resulting etched textured or anti-glare surface, chemically strengthening the textured or anti-glare surface, applying a functional coating or film (e.g., a light sensitive or polarizing film) or protective surface coating or film, and like coatings or films, or a combination thereof.

In embodiments, when a single-side acid-etch, or like modification is desired on a sheet of glass, one side of the glass can be protected from the etching solution. Protection can be achieved, for example, by applying an insoluble non-porous coating such as an acrylic wax, or a laminate film having an adhesive layer, for example, an acrylic, a silicone, and like adhesives materials, or combinations thereof. Coating application methods can include, for example, brushing, rolling, spraying, laminating, and like methods. The acid-etch exposed insoluble non-porous protective coating survives the etching process and can be readily removed after the etching. Removing the protective film from the surface of the article can be accomplished using any suitable method, such as contacting the protective film with a dissolving liquid, heating the film to liquefy and drain, and like methods and materials, or a combination thereof. Thus, the preparative method can optionally further include, prior to etching, contacting at least another surface, e.g., a second surface such as the backside of a glass sheet, of the article with an optionally removable, etch-resistant protective layer.

In embodiments, the disclosure provides an article prepared by any of the preparative processes disclosed herein, such as a glass article prepared by the above mentioned grit blasting, and etching steps. In embodiments, the preparative processes can be accomplished sequentially, simultaneously, continuously, semi-continuously, batch-wise, and like permutations, or combinations thereof.

In embodiments, the method can optionally further include removing any residual particles from the glass surface after the etching step, removing any protective film layers, and can also involve subsequent etching steps that occur after the particles and protective films have been removed from the glass. These subsequent etching steps can further modify the surface roughness profile of the glass or the glass surface chemistry.

In embodiments, the at least one surface of the article can be a glass, the grit particles can be particles suitable for sand blasting, and the etchant can be at least one acid or mixture of acids.

In embodiments, the glass article having anti-glare surface of the disclosure can comprise a distribution of topographic features having an average diameter of about 0.1 to about 100 micrometers, about 0.1 to about 50 micrometers, about 0.1 to about 30 micrometers, and like ranges, including intermediate values and ranges.

In embodiments, the disclosure provides an article or device including at least one glass article having a textured surface prepared by the disclosed method of making.

In embodiments, the disclosure provides a wet etch process to form a uniform, nano- to micro-scale textured surface on most silicate glasses and without having a significant impact on chemical strengthening capability of the glass. The process includes grit blasting a glass surface, followed by acid etching of the blasted surface, such as in an HF, or multi-component acid solution. In embodiments, the acid etch solution can preferentially or selectively etch the glass surface irregularities or islands on the glass surface, and can also reduce the surface roughness.

In embodiments, the desired reduced gloss or glare levels can be obtained, for example, by adjusting at least one or more of the following parameters: the level or amount of (i.e., duration) of grit blasting, the particle size distribution (PDS) of the grit particles used, the concentration of the acid etchant, and the exposure interval or the time that the grit blasted surface of the glass sample is in contact with the acid etchant.

In embodiments, an intermediate textured-surface glass article is provided from the grit blasting and acid etching steps. The textured-surface glass article can be ion-exchangeable and can have at least one roughened surface. The roughened surface has a distinctness-of-reflected image (DOI) of less than 90 when measured at an incidence angle of 20° (DOI at 20°). A pixelated display system that includes the anti-glare glass article is also provided. The glass article can be, for example, a planar sheet or panel having two major surfaces joined on the periphery by at least one edge, although the glass article can be formed into other shapes such as, for example, a three-dimensional shape. At least one of the surfaces is a roughened surface including, for example, topological or morphological features, such as, projections, protrusions, depressions, pits, closed or open cell structures, particles, islands, lands, trenches, fissures, crevices, and like geometries and features, or combinations thereof.

In embodiments, the disclosure provides an aluminosilicate glass article. The aluminosilicate glass article can include, for example, at least 2 mol % Al₂O₃, can be ion-exchangeable, and can have at least one roughened surface. The aluminosilicate glass article can have at least one roughened surface comprising a plurality of topographical features. The plurality of topographical features can have an average characteristic largest feature size (ALF) of from about 1 micrometer to about 50 micrometers.

In embodiments, the disclosure provides a low cost method of making textured Gorilla® glass for use, for example, in non-display applications, including for example, track pads and key board decks. Tactile feel of the touch surface is significant for these applications and can be achieved by texturing glass. The ion-exchange process imparts strength and durability to the glass. In embodiments of the disclosed process, glass is grit-blasted with small mesh grit (e.g., 2 to 40 microns, and 10 to 40 microns in diameter) and acid etched in an etchant mixture, such as a hydrofluoric acid/sulfuric acid mixture, to produce the desired texture having a roughness average (Ra) of about 50 nanometers to 1.3 microns. Advantages of the disclosed process and resulting glass articles can include, for example, the roughened, ion-exchanged glass provides a superior alternative to plastic in, for example, strength, abrasion resistance, tactile feel, and the ability to hide finger prints. A textured glass surface of the disclosure can have superior aesthetics properties compared to the plastic or resin surfaces. The finger print resistance of the roughened glass can be further improved by coatings such as Easy-to-Clean following the ion-exchange step.

In embodiments, the at least one roughened surface of the glass article has an average RMS roughness can be from about 10 nm to about 800 nm, from about 40 nm to about 500 nm, and from about 40 nm to about 300 nm. In embodiments, the average RMS roughness can be greater than about 10 nm and less than about 10% of the ALF, greater than about 10 nm and less than about 5% of ALF, and greater than about 10 nm and less than about 3% of ALF.

The specification of low DOI and high Ros/Rs provide constraints on the characteristic feature size and ALF. For a given roughness level, larger feature sizes result in lower DOI and higher Ros/Rs. Therefore, to balance the DOI and roughness targets, in embodiments, one can create anti-glare surfaces having an intermediate characteristic feature size that is neither too small nor too large. In display-cover applications, one can minimize reflected or transmitted haze when the transmitted haze is scattering into very high angles that can cause a milky white appearance of a roughened article under ambient lighting.

“Transmission haze,” “haze,” or like terms refer to the percentage of transmitted light scattered outside an angular cone of ±4.0° according to ASTM D1003. For an optically smooth surface, the transmission haze is generally close to zero. Transmission haze of a glass sheet roughened on two sides (Haze2-side) can be related to the transmission haze of a glass sheet having an equivalent surface that is roughened on only one side (Hazel-side), according to the approximation of eq. (2):

Haze_{2-side}≈[(1−Haze_{1-side})·Haze_{1-side}]+Haze_{1-side} (2).

Haze values are usually reported in terms of percent haze. The value of Haze2-side from eq. (2) must be multiplied by 100. In embodiments, the disclosed glass article can have a transmission haze of less than about 50% and even less than about 30%.

A multistep surface treatment process has been used to form the roughened glass surface. An example of a multistep etch process is disclosed in commonly owned co-pending U.S. Publication No. 2010/0246016, filed Mar. 31, 2009, to Carlson, et al., entitled “Glass Having Anti-Glare Surface and Method of Making,” where a glass surface is treated with a first etchant to form crystals on the surface, then etching a region of the surface adjacent to each of the crystals to a desired roughness, followed by removing the crystals from the glass surface, and reducing the roughness of the surface of the glass article to provide the surface with a desired haze and gloss.

In embodiments, various performance enhancing additives can be included in the grit blast particle formulation, the etch solution, or both, including for example, a surfactant, a co-solvent, a diluent, a lubricant, a gelation agent, a charge control agent, and like additives, or combinations thereof. In embodiments, the surfactant can preferably be a perfluorinated surfactant, such a Tomamin® surfactant.

The contacting the particulated surface with an etchant can involve, for example, selective partial or complete dipping, spaying, immersion, and like treatments, or a combination of treatments, with an acidic etch solution including, for example, 2 to 10 wt % hydrofluoric acid and 2 to 30 wt % of a mineral acid, such as hydrochloric acid, sulfuric acid, nitric acid, phosphoric acid, and like acids, or combinations thereof. The glass surface can be etched in the solution for periods of from about 1 second to about 10 minutes, including intermediate values and ranges. The disclosed concentrations and etch times are representative of suitable examples. Concentrations and etch times outside the disclosed ranges can also be used to obtain the roughened surface of the glass article albeit potentially less efficiently. Other etch concentrations can be, for example, 3 M HF/3.6 M H₂SO₄, 5.5 M HF/6.5 M H₂SO₄, 6 M HF/7 M H₂SO₄, and like etch compositions and concentrations, including intermediate values and ranges, and compositions.

In chemical strengthening, larger alkali metal ions are exchanged for smaller mobile alkali ions near the glass surface. This ion-exchange process places the surface of the glass in compression, allowing it to be more resistant to any mechanical damage. In embodiments, the outer surface of the glass article can optionally be ion-exchanged where smaller metal ions are replaced or exchanged by larger metal ions having the same valence as the smaller ions. For example, sodium ions in the glass can be replaced with larger potassium ions by immersing the glass in a molten salt bath containing potassium ions. The replacement of smaller ions with larger ions creates a compressive stress within the layer. Alternately, in embodiments, the larger ions near the outer surface of the glass can be replaced by smaller ions, for example, by heating the glass to a temperature above the strain point of the glass. Upon cooling to a temperature below the strain point, a compressive stress is created in an outer layer of the glass. Chemical strengthening of the glass can optionally be performed after the surface roughening treatment, with little negative effect on the ion-exchange behavior or the strength of the glass article.

In embodiments, the disclosure provides a method for making an anti-glare surface including, for example, “projecting particles” (i.e., blasting) a surface with particles, such as with a liquid-free or liquid containing particle dispersion, etching the particle blasted with a suitable etchant, ion-exchanging the etched surface, and optionally accomplishing further processing to reduce objectionable surface flaws (i.e., flaw reduction).

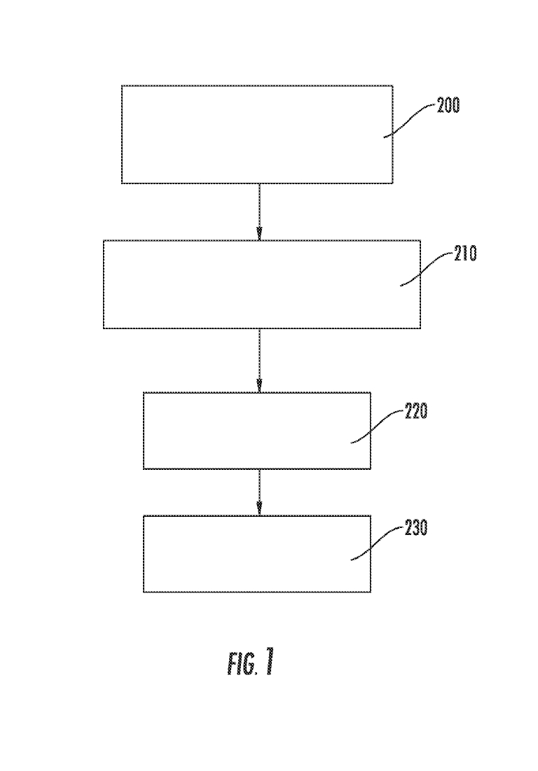

Referring to the figures, FIG. 1 shows an exemplary flow chart for the disclosed process. In embodiments, the process can include, for example, optionally cutting the glass work piece to size; optionally cleaning the glass work piece to remove surface debris or contamination; optionally laminating a polymer film or like protective layer on one side or portion of the work piece for surface protection during processing; grit blasting (200) the un-laminated side of the work piece; optionally rinsing the work piece to remove the grit residue; acid etching (210) by immersing in an etch bath including, for example, a mixture of hydrofluoric acid and sulfuric acid; optionally rinsing (220) the glass again to remove acid residue; optionally drying the work piece; optionally removing the film on the reverse side of the glass; optionally rinsing; optionally drying, optionally cutting the work piece, ion exchanging (230) the work piece; and optionally performing additional post-processing operations, such as rinsing, drying, coating, packaging, and like operations.

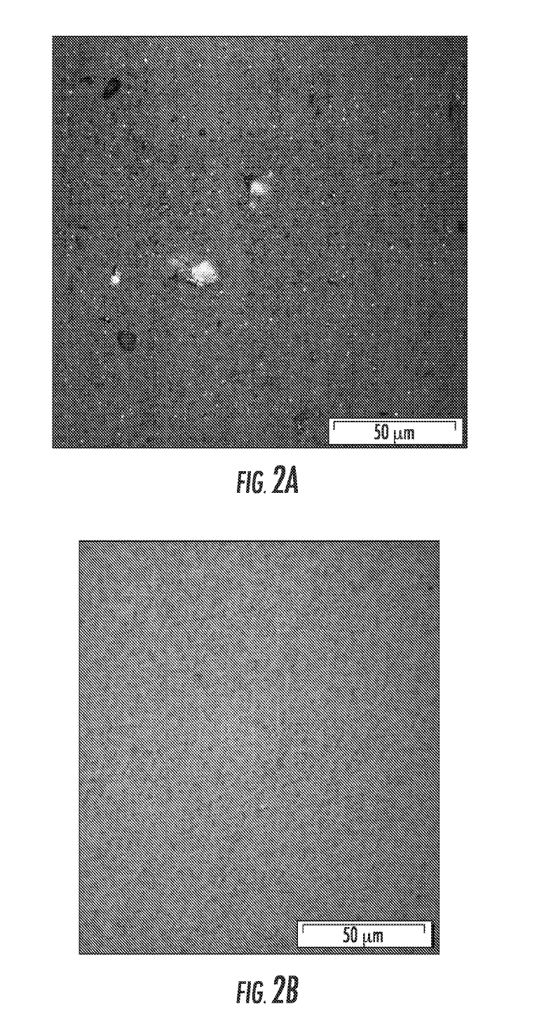

FIGS. 2A and 2B, respectively, show micrograph images after grit blasting for a comparative process (FIG. 2A) having poor grit pressure and flow control that produces chips, and an inventive process (FIG. 2B), having grit pressure and flow control, that produces no chips. The light or bright spots in FIG. 2A are chips in the glass. The chips are deep indentations and can cause uneven etching in the etching step. The inventive process, in contrast, produces uniform and well controlled features after the grit blasting. The conditions for grit blasting in the inventive process are listed in Table 2. The conditions for grit blasting in the comparative process are, for example, white alumina as the grit, air pressure 40 psi, grit flow by syphon feed and are listed in Table 3. The inventive process parameters are: 10 micron white alumina, blasting air pressure of 29 psi, and a grit flow rate of 100 g/min and are also listed in Table 3.

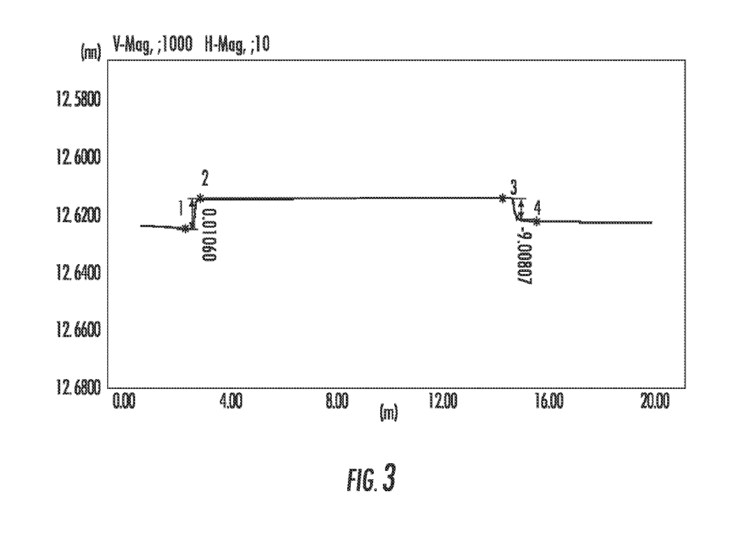

FIG. 3 shows an exemplar of acceptable glass thickness loss in the disclosed process during etching, e.g., about 9 microns.

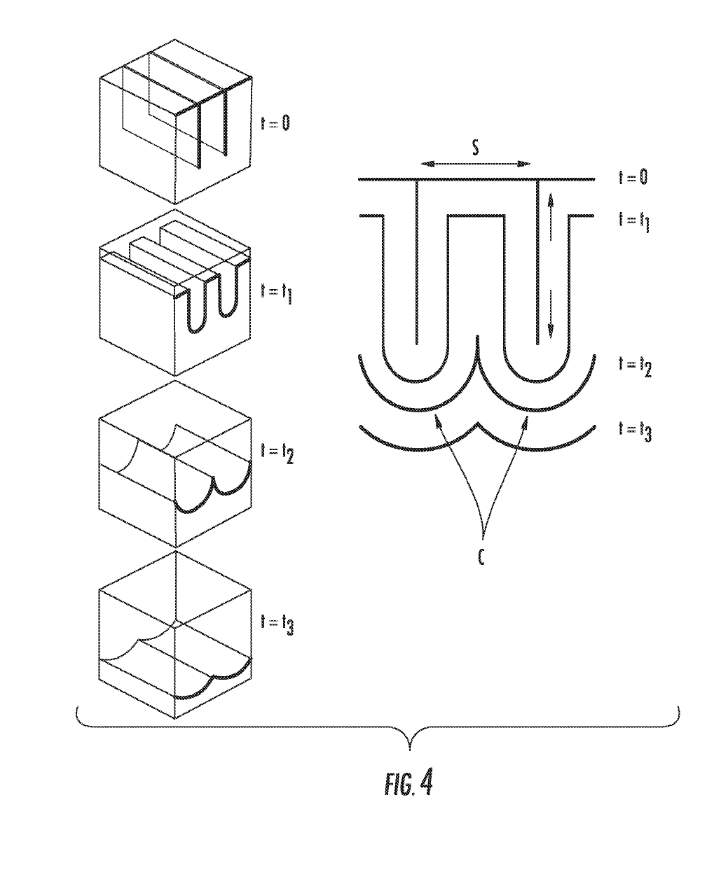

FIG. 4 is a schematic showing progressive surface roughness transformation during etching of the grit blasted surface. “S” is the crack surface separation dimension after blasting. “D” is the average depth of the indents. “C” is the circular geometry of the resulting blasted and etched surface and before ion-exchange. Sub-surface damage (such as the crack tips shown at t=0), above a threshold level is believed, although not bound by theory, to be significant for disclosed process. This sub-surface damage can be readily obtained in the grit blasting step. Acid etching is then used to heal the cracks formed grit blast damage. Acid etching can include, for example, mixtures of HF and a mineral acid, such as HCl or H₂SO₄. Shorter etching times can result in a rougher surface with higher haze. Longer etching results in lower haze. Acid etchant concentrations and etching times provide a means to control surface texture properties. The comparative and inventive processes differ in the average spacing (“S”) and depth of indents created on the glass surface by the blasting process. The average spacing of indents in the comparative process is about 3 microns, and the average spacing of indents in the new process is about 1 micron. The average depth of the indents (“D”) is 1.2 and 0.9 microns, respectively, for the comparative and inventive processes. The average diameter “C” of the resulting etched surface is about 13 microns for the comparative process and about 7 microns for the inventive process.

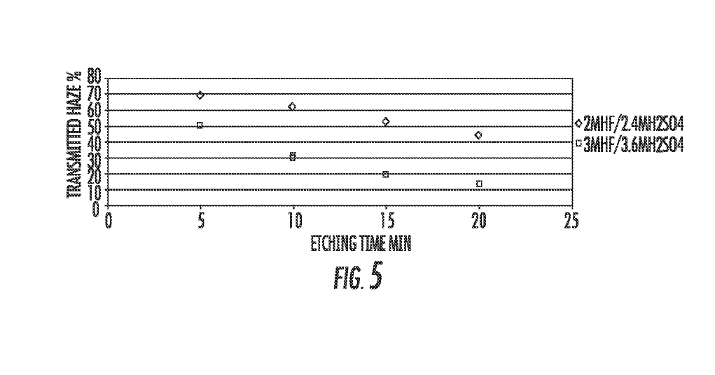

FIG. 5 shows the effect of acid concentration and etch time on haze properties. For a HF/H₂SO₄ mixture at a concentration of 2 M HF/2.4 M H₂SO₄, the etching time impacts the glass thickness loss. For example, the longer the etching time, the greater the glass thickness loss. The same effect can be seen when a HF/H₂SO₄ mixture at a concentration of 3M HF/3.6M H₂SO₄ is used. The higher concentration of acid results in a greater rate of glass thickness loss. The thickness loss measured here is an index of etching rate. The etching rate directly controls the depth of the valleys and the height of the peaks in the etched glass surface. The etch time and acid bath strength are two process parameters that can be used in the disclosed etching step to control the loss of glass thickness.

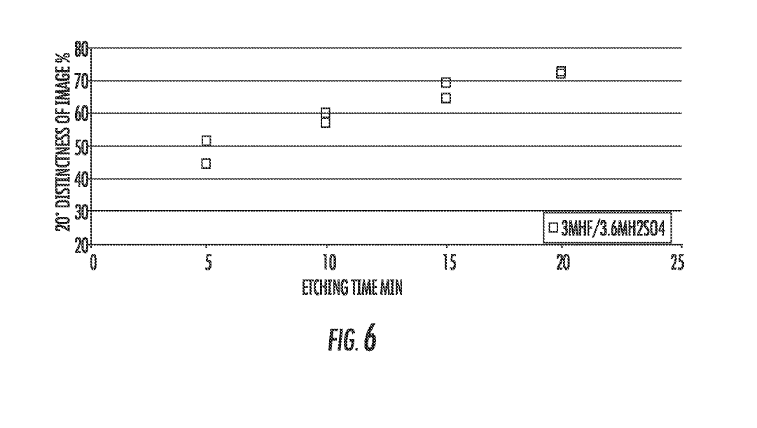

FIG. 6 shows the effect of acid concentration and etch time on the distinctness of image (DOI) properties. Acid etching time is a process variable that aids in controlling the distinctness of image as the glass is etched for longer periods, the distinctness of image increases, in this instance from 45% for 5 minutes of etching to 73% for 20 minutes of etching using a 2 M HF/2.4 M H₂SO₄ mixture.

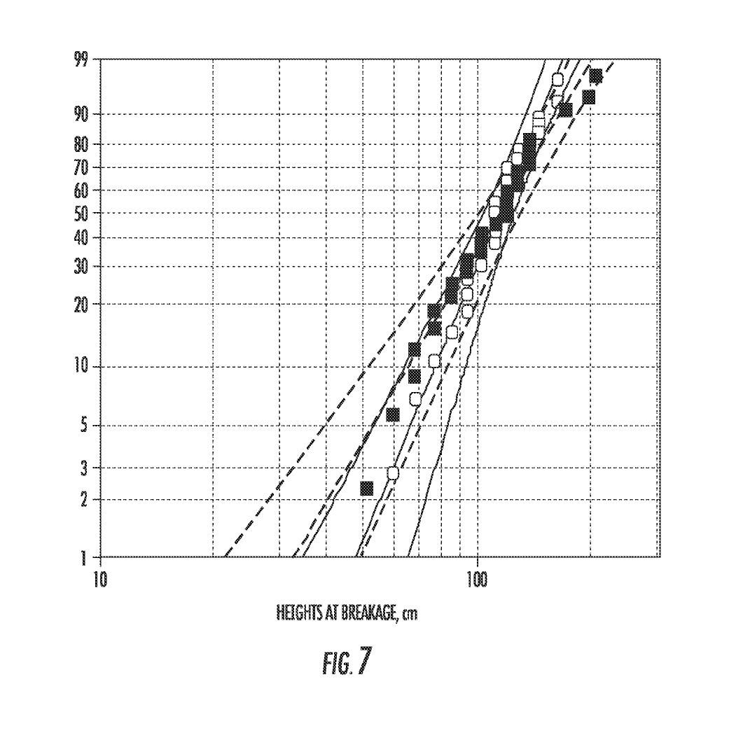

FIG. 7 shows a Weibull plot that compares a Gorilla® glass (control) with an experimental glass specimen of the disclosure that has been grit blasted with 1500 mesh white alumina and etched with acid. The control and experimental glass data sets were overlaid together, and the results indicate that there was no strength loss in the grit blasted and etched experimental specimen. The grit blaster nozzle interior diameter (ID) was 9 mm. The blasting pressure was 0.2 MPa. The part-to-nozzle distance was 150 mm. The blaster nozzle traverse speed was 30 m/min, and pitch was 5 per mm. The number of blaster passes was 2. In embodiments, the blaster can have one or more, nozzles, such as 1 to 5 nozzles or more, including intermediate values and ranges. The etching conditions were 2M HF/2.4 M H₂SO₄ for 10 min. The results demonstrate that the grit blasted, etched, and ion-exchanged 2318 glass specimens of the present disclosure are as strong as un-abraded Gorilla® glass.

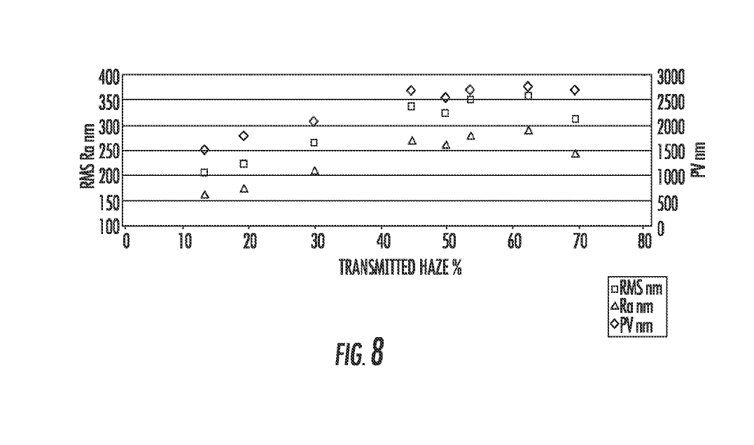

FIG. 8 shows a correlation between transmitted haze and surface roughness parameters. These measurements were taken using a white light interferometer New View 5000 available from Zygo Corp. The magnification used for roughness measurement was 800×. The surface roughness parameters of Ra, RMS, and PV (all in nanometers), correlate well with haze, which is an index of the ability of a surface to scatter light. When incident light on a surface is scattered, the reflected images on the surface are diffuse.

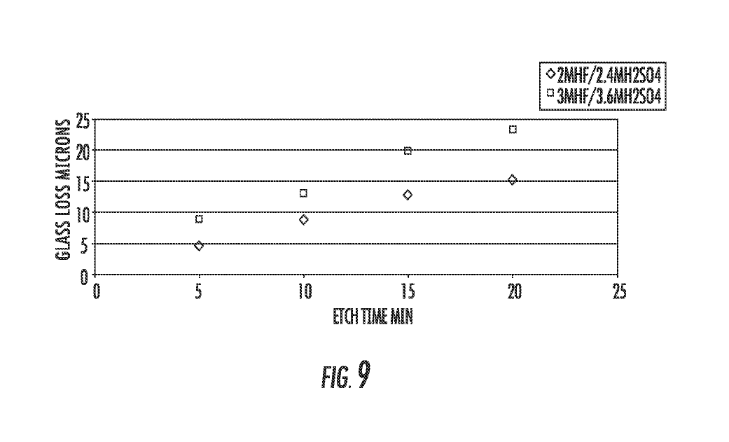

FIG. 9 shows glass thickness loss as a function of the etch time and acid concentration. The etchant having 3 M HF/3.6 M H₂SO₄ consistently provides greater glass thickness loss compared to the 2 M HF/2.4 M H₂SO₄ etchant. A glass thickness loss of less than 50 microns is desired for process control and low warp. The disclosed process can achieve a wide range of optical properties, for example, a broad range of haze values from 10 to 70% range in haze by varying acid concentrations and etch times.

The disclosed etch method can be accomplished quickly, for example, in from about 1 second to about 10 minutes, from about 1 second to about 5 minutes, including intermediate values and ranges, such as in from about 2 second to about 4 minutes total etch time, to create an anti-glare layer on a glass surface. A conventional multi-bath method can take about 60 minutes or more. The disclosed etch method can use a single chemical etchant bath (e.g., HF and H₂SO₄) instead of three or more baths used in conventional processes.

In embodiments, the disclosed method can etch away, for example, from about 1 to about 50 micrometers of the substrate being etched (i.e., into the plane of the substrate or the z-direction), from about 1 to about 30 micrometers of the substrate, from about 1 to about 20 micrometers of the substrate, from about 1 to about 10 micrometers of the substrate, including intermediate values and ranges, to create a desired anti-glare layer. In contrast, a conventional etch process can typically remove about 100 to about 200 micrometers of the glass surface.

Samples prepared with the disclosed process show similar optical properties (e.g., haze, gloss, and distinctness of image (DOI)) when compared with samples etched with a conventional process, but the present method and samples are advantaged by having substantial reductions in process time and costs. The disclosed process is readily scaled-up for large parts, such as a one square meter glass sheet, and above, while a conventional dip process is less readily scalable for larger units.

Some significant benefits or advantages of the disclosed process compared to the other processes are mentioned below.

Haze can be adjustable from very low to very high values. Low haze is desirable for applications requiring high display contrast, while high haze is useful for optical designs requiring scattering (such as edge illumination) or for aesthetic reasons such as reducing the “black hole” appearance of the display in the off state. The preference for low vs. high haze (and the acceptance of performance trade-offs) are typically driven by customer or end-user preferences, and the final application and use mode.

Roughness can be adjusted, for example, from very low to very high values. Low roughness is generally used to create small-angle scattering, resulting in low DOI with low haze and corresponding high display contrast. However, high roughness is desirable for some applications, such as in some touch-display devices where a rough surface provides a “gliding feel” for a user's finger. This effect of high roughness is also useful in non-display applications, such as mouse pad surfaces. For these touch applications, it is also desirable to post-treat the rough surface with a low-surface energy coating such as a fluorosilane, as we have demonstrated in separate experiments for various anti-glare (AG) types surfaces. The low-surface energy coating reduces surface friction, improves the “gliding feel” effect, and also makes the surfaces less wettable by oil and water, and easier to clean.

The widely adjusted haze and roughness values were achieved using short etch times (e.g., 30 seconds) and very little glass thickness loss (e.g., less than 5 microns) relative to our aforementioned earlier anti-glare processes.

In embodiments, the glass article can comprise, consist essentially of, or consist of one of a soda lime silicate glass, an alkaline earth aluminosilicate glass, an alkali aluminosilicate glass, an alkali borosilicate glass, and combinations thereof. In embodiments, the glass article can be, for example, an alkali aluminosilicate glass having the composition: 60-72 mol % SiO₂; 9-16 mol % Al₂O₃; 5-12 mol % B₂O₃; 8-16 mol % Na₂O; and 0-4 mol % K₂O, wherein the ratio

$$\frac{{Al}_{2} {O}_{3} ( mol \% ) + {B}_{2} {O}_{3} ( mol \% )}{\sum alkali metal modifiers ) ( mol \% )} > 1 ,$$

where the alkali metal modifiers are alkali metal oxides. In embodiments, the alkali aluminosilicate glass substrate can be, for example: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO. In embodiments, the alkali aluminosilicate glass substrate can be, for example: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %. In embodiments, the alkali aluminosilicate glass substrate can be, for example: 64-68 mol % SiO₂; 12-16 mol % Na₂O; 8-12 mol % Al₂O₃; 0-3 mol % B₂O₃; 2-5 mol % K₂O; 4-6 mol % MgO; and 0-5 mol % CaO, wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)−Al₂O₃≦2 mol %; 2 mol %≦Na₂O−Al₂O₃≦6 mol %; and 4 mol %≦(Na₂O+K₂O)≦Al₂O₃≦10 mol %. In embodiments, the alkali aluminosilicate glass can be, for example: 50-80 wt % SiO₂; 2-20 wt % Al₂O₃; 0-15 wt % B₂O₃; 1-20 wt % Na₂O; 0-10 wt % Li₂O; 0-10 wt % K₂O; and 0-5 wt % (MgO+CaO+SrO+BaO); 0-3 wt % (SrO+BaO); and 0-5 wt % (ZrO₂+TiO₂), wherein 0≦(Li₂O+K₂O)/Na₂O≦0.5.

In embodiments, the alkali aluminosilicate glass can be, for example, substantially free of lithium. In embodiments, the alkali aluminosilicate glass can be, for example, substantially free of at least one of arsenic, antimony, barium, or combinations thereof. In embodiments, the glass can optionally be batched with 0 to 2 mol % of at least one fining agent, such as Na₂SO₄, NaCl, NaF, NaBr, K₂SO₄, KCl, KF, KBr, SnO₂, and like substances, or combinations thereof.

In embodiments, the selected glass can be, for example, down drawable, i.e., formable by methods such as slot draw or fusion draw. In these instances, the glass can have a liquidus viscosity of at least 130 kpoise. Examples of alkali aluminosilicate glasses are described in commonly owned and assigned U.S. patent application Ser. No. 11/888,213, to Ellison, et al., entitled “Down-Drawable, Chemically Strengthened Glass for Cover Plate,” now U.S. Pat. No. 7,666,511, issued Feb. 23, 2010, and its priority applications. The glass surfaces and sheets described in the following example(s) can be any suitable grit blastable and acid etchable glass substrate or like substrates, and can include, for example, a glass composition 1 through 11, or a combination thereof, listed in Table 1.

### EXAMPLES

The following examples serve to more fully describe the manner of using the above-described disclosure, and to further set forth the best modes contemplated for carrying out various aspects of the disclosure. The examples do not limit the scope of this disclosure, but rather are presented for illustrative purposes. The working examples further describe how to prepare the articles of the disclosure.

### Example 1

### Grit Blasting Procedure

Non-ion exchanged (non-IOX) 2318 glass was grit blasted with 130 mesh SiC grit (10 to 35 micrometer particle size) and etched in HF/H₂SO₄ mixtures. Grit blasting conditions for 130 mesh SiC were varied and optical properties were measure after etching parts in 3 M HF/3.6 M H₂SO₄ for 5 minutes. The optical properties and surface roughness are outlined in the Table 2.

### Results

Based on the data in Table 1, process conditions for sample making focused on blasting glass specimens with 130 mesh SiC grit at 10 psi for 10 passes, and etching with 3M HF/3.6 M H₂SO₄ for 5 min. Glass thickness loss for this process was acceptable at about 9 microns, and as seen in FIG. 3.

### Example 2

### Acid Etching Procedure

HF and the mineral acid solutions are mixed separately at the required concentrations, by carefully diluting concentrated acids with deionized water. HF concentration can vary from 2% to 20% w/v, including intermediate values and ranges. The mineral acid concentration can vary from 5 to 35% w/v. The diluted HF and mineral acid are mixed and allowed to cool; mixing of HF with other acids is an exothermic reaction. Next 0.01 to 1 wt % surfactant is added at this stage. The acid mixture is charged into the etching tank. Then 8 liters of acid mixture is used to etch 40 glass sheets 250 mm×350 mm. The glass sheets to be etched are clamped to an immersion fixture and the fixture is dipped into the acid bath so as to completely immerse the glass sheets in the acid bath. The etch step can vary in duration, for example, from 1 sec to 30 minutes. Long etch times for low haze and short etch times for high haze is preferred. The temperature of the acid bath can vary from, for example, 15° C. to 35° C.

### Results

After immersion in the acid bath the glass surface is etched, but contains acid residue and dissolved glass. These are removed by a rinse process described below.

### Example 3

### Washing and Drying Procedure

The acid sheets are withdrawn from the acid bath after the etch cycle is complete and rinsed in a tank with 8 liters of deionized water at room temperature for 1 to 2 minutes with agitation. The sheets are air dried and the protective coating is removed.

### Results

The above procedure results in a sheet of glass with one surface having a texture consisting of peaks and valleys that diffuse light. The diffusivity varies with etching time and the concentration of the etchants used.

### Example 4

### Ion Exchange Procedure

Etched glass sheets are loaded in a fixture and immersed in a potassium nitrate bath for ion exchange. The ion-exchange temperatures range from 350° C. to 480° C. and the cycle time varies from 2 to 10 hours. After removal from the salt bath, the glass is rinsed thoroughly with distilled water and air dried.

### Results

At this stage the glass sheets have a texture on one side consisting of peaks and valleys that diffuse light, and possess substantially the same strength of un-textured ion exchanged glass which has not been grit blasted or etched. The strength comparison can be seen in the Weibull plots in FIG. 7.

### Example 5

### Post Procedure Finishing

The glass sheets with the desired surface texture on one side at the targeted levels of haze and DOI are cut to size and prepared for installation in a device, such as a display or non-display device.

### Results

Upon completion of the process sequence described in Examples 1 through 5, a glass sheet with one light diffusing surface that has diffusivity higher than an un-textured sheet of Gorilla® glass, and mechanical strength equal to that of un-textured Gorilla® glass is obtained. It is not possible to grit blast and etch Gorilla® glass without damaging glass strength and flatness.

The disclosure has been described with reference to various specific embodiments and techniques. However, it should be understood that many variations and modifications are possible while remaining within the scope of the disclosure.

TABLE 1
Representative glass substrate compositions.

| Oxides | Glass | | | | | | | | | | |
|---|---|---|---|---|---|---|---|---|---|---|---|
| (mol %) | 1 | 2 | 3 | 4 | 5 | 6 | 7 | 8 | 9 | 10 | 11 |
| SiO₂ | 66.16 | 69.49 | 63.06 | 64.89 | 63.28 | 67.64 | 66.58 | 64.49 | 66.53 | 67.19 | 70.62 |
| Al₂O₃ | 10.29 | 8.45 | 8.45 | 5.79 | 7.93 | 10.63 | 11.03 | 8.72 | 8.68 | 3.29 | 0.86 |
| TiO₂ | 0 | | | — | — | 0.64 | 0.66 | 0.056 | 0.004 | — | 0.089 |
| Na₂O | 14 | 14.01 | 15.39 | 11.48 | 15.51 | 12.29 | 13.28 | 15.63 | 10.76 | 13.84 | 13.22 |
| K₂O | 2.45 | 1.16 | 3.44 | 4.09 | 3.46 | 2.66 | 2.5 | 3.32 | 0.007 | 1.21 | 0.013 |
| B₂O₃ | 0.6 | | 1.93 | — | 1.9 | — | — | 0.82 | — | 2.57 | — |
| SnO₂ | 0.21 | 0.185 | — | — | 0.127 | — | — | 0.028 | — | — | — |
| BaO | 0 | — | — | — | — | — | — | 0.021 | 0.01 | 0.009 | — |
| As₂O₃ | 0 | — | — | — | — | 0.24 | 0.27 | | — | 0.02 | — |
| Sb₂O₃ | — | — | 0.07 | — | 0.015 | — | 0.038 | 0.127 | 0.08 | 0.04 | 0.013 |
| CaO | 0.58 | 0.507 | 2.41 | 0.29 | 2.48 | 0.094 | 0.07 | 2.31 | 0.05 | 7.05 | 7.74 |
| MgO | 5.7 | 6.2 | 3.2 | 11.01 | 3.2 | 5.8 | 5.56 | 2.63 | 0.014 | 4.73 | 7.43 |
| ZrO₂ | 0.0105 | 0.01 | 2.05 | 2.4 | 2.09 | — | — | 1.82 | 2.54 | 0.03 | 0.014 |
| Li₂O | 0 | — | — | — | — | — | — | — | 11.32 | — | — |
| Fe₂O₃ | 0.0081 | 0.008 | 0.0083 | 0.008 | 0.0083 | 0.0099 | 0.0082 | 0.0062 | 0.0035 | 0.0042 | 0.0048 |
| SrO | — | — | — | 0.029 | — | — | — | — | — | — | — |

TABLE 2
Grit blasting conditions and optical properties of 2318 glass.

| | | Blasting | | | | | | |
|---|---|---|---|---|---|---|---|---|
| | Number of | pressure- | Distinctness of | Transmitted | Peak to valley | Root mean | Roughness average | |
| Sample | passes | (psi) | image at 20 deg | Haze | distance (microns) | square (microns) | (Ra in microns) | rms/Ra |
| 1 | 4.0 | 5.0 | 97.3 | 21.4 | | | | |
| 2 | 4.0 | 5.0 | 88.3 | 34.7 | | | | |
| 3 | 4.0 | 5.0 | 90.0 | 18.8 | | | | |
| 4 | 12.0 | 5.0 | 84.4 | 26.6 | | | | |
| 5 | 12.0 | 5.0 | 78.9 | 36.6 | | | | |
| 6 | 12.0 | 5.0 | 86.8 | 41.5 | | | | |
| 7 | 8.0 | 10.0 | 0.0 | 74.9 | | | | |
| 8 | 8.0 | 10.0 | 64.1 | 73.4 | 8.35 | 0.97 | 0.73 | 1.33 |
| 9 | 8.0 | 10.0 | 58.6 | 72.9 | | | | |
| 10 | 12.0 | 10.0 | 0.0 | 76.0 | | | | |
| 11 | 12.0 | 10.0 | 0.0 | 75.6 | | | | |
| 12 | 12.0 | 10.0 | 0.0 | 73.9 | | | | |
| 13 | 4.0 | 10.0 | 90.1 | 43.0 | | | | |
| 14 | 4.0 | 10.0 | 86.1 | 46.1 | | | | |
| 15 | 4.0 | 10.0 | 84.5 | 46.7 | | | | |
| 16 | 12.0 | 20.0 | 0.0 | 87.7 | | | | |
| 17 | 12.0 | 20.0 | 0.0 | 88.1 | 10.10 | 1.20 | 0.91 | 1.31 |
| 18 | 12.0 | 20.0 | 0.0 | 88.3 | | | | |

TABLE 3

| | | | | | Average spacing | Average depth | |
|---|---|---|---|---|---|---|---|
| | Grit | Grit Size | Air Pressure | | (“S”) of indents | (“D”) of indents | Average diameter |
| | Material | (in microns) | (psi) | Grit Flow | (in microns) | (in microns) | (“C”) (in microns) |
| Comparative | white | 10 | 40 | gravity | 3 | 1.2 | 13 |
| Method | alumina | | | feed | | | |
| Inventive | white | 10 | 29 | 100 g/min | 1 | 0.9 | 7 |
| Method | alumina | | | | | | |

What is claimed is:

1. A method of making an article having a textured glass surface, comprising:
grit blasting a portion of the surface of a non-ion exchanged glass work piece;
acid etching at least a portion of the grit blasted surface of the glass work piece with an acid mixture; and
ion exchanging the surface of the acid etched and grit blasted glass work piece.

2. The method of claim 1 wherein the diameter of the grit in the grit blasting is from 2 to 40 microns.

3. The method of claim 1 wherein the grit in the grit blasting is SiC having particle size of from 2 to 50 microns.

4. The method of claim 1 wherein the acid in the acid etching comprises a mixture of HF, and an acid selected from H₂SO₄, HCl, HNO₃, H₃PO₄, or a combination thereof.

5. The method of claim 1 wherein the acid etching comprises contacting the glass work piece with an acid mixture of 3M HF and 3.6 M H₂SO₄ for 1 second to 10 minutes.

6. The method of claim 1 wherein the grit blasting and acid etching produce an intermediate glass work piece having a textured surface having an average roughness (Ra) of from 50 nm to 1.3 microns.

7. The method of claim 1 further comprising treating the resulting ion exchanged glass with a low-surface energy coating.

8. The method of claim 1 wherein the glass surface comprises at least one of a soda lime silicate glass, an alkaline earth aluminosilicate glass, an alkali aluminosilicate glass, an alkali borosilicate glass, a boroaluminosilicate glass, or a combination thereof.

9. The method of claim 1 wherein grit blasting comprises exposing the glass surface to the grit blast particles for from 1 to 100 grams per minute for from 1 to 50 passes, using 1 to 5 nozzles.

10. The method of claim 1 wherein acid etching comprises exposing the glass surface to the etchant for about 1 second to about 30 minutes, and optionally in the presence of a surfactant.

11. The method of claim 1 further comprising washing and drying the resulting grit blasted surface, the acid etched surface, the ion exchanged surface, or a combination thereof.

12. The method of claim 1 further comprising, prior to grit blasting or acid etching, contacting at least another surface of the article with an optionally removable, blast-resistant or etch-resistant protective layer.

13. A glass article prepared by the process of claim 1.

14. The glass article of claim 13 wherein the glass article is a portion of non-display device.
